(19) United States
(12) Patent Application Publication
(10) Pub. No.: US 2023/0049228 A1
(43) Pub. Date: Feb. 16, 2023

(54) SOLUTION FOR GENERATING A TOUCHLESS ELEVATOR CALL

(71) Applicant: KONE CORPORATION, Helsinki (FI)

(72) Inventors: Tapani Talonen, Helsinki (FI); Antti Perko, Helsinki (FI); Max Wong, Helsinki (FI); Joe Wong, Helsinki (FI); Jussi Laurila, Helsinki (FI); Visa Rauta, Helsinki (FI)

(73) Assignee: KONE CORPORATION, Helsinki (FI)

(21) Appl. No.: 17/974,993

(22) Filed: Oct. 27, 2022

Related U.S. Application Data
(63) Continuation of application No. PCT/FI2020/050280, filed on Apr. 29, 2020.

(51) Int. Cl. B66B 1/34; B66B 1/24

(52) U.S. Cl. CPC B66B 1/3446; B66B 1/2408; B66B 2201/4676

(57) ABSTRACT

The invention relates to a method for generating an elevator call. The method comprises: obtaining (202) image data representing at least one symbol (310, 310a, 310b) illustrated on a symbol representing device (320) from at least one image sensing device (112), identifying (204) the at least one symbol (310, 310a, 310b) from the obtained image data, and generating (206) the elevator call in accordance with the identified at least one symbol (310, 310a, 310b). The invention relates also to an elevator control unit (108) and an elevator system (100) performing at least partly the method.

### TECHNICAL FIELD

The invention concerns in general the technical field of elevators. Especially the invention concerns generating elevator calls.

### BACKGROUND

Typically, elevators may be public conveying devices in residential buildings and especially at traffic junctions, such as airports, railway stations, underground station, shopping centers, hospitals, sports centers, exhibition centers, cruise ships, etc., in which the use of the elevator may be necessary or even unavoidable for several user groups, such as physically disabled and/or users with a stroller. Especially, in public places a large number of people are using the same call devices to make elevator calls via a physical contact, e.g. a touch by a hand, causing that the elevator call devices and/or elevator buttons of the elevator call devices may efficiently spread viruses and bacteria.

The elevator buttons may be coated with an antibacterial coating to reduce at least partly the spreading of the viruses and bacteria. However, coating the elevator buttons may be costly. Alternatively or in addition, making the elevator calls may be based on voice control in order to avoid the physical contact. However, especially in public places the reliability of voice control may suffer from surrounding noise. Alternatively or in addition, the elevator calls may be combined with an access control. The access control allows access only for authorized users and in response to identification the authorized user, the elevator call may be generated. The access control may be based on using keycards; tags; and/or biometric technologies, such as fingerprint, facial recognition, iris recognition, retinal scan, etc. However, the access control-based elevator calls may be generated only in systems based on the access control, which may typically be used only in environments, in which access control may be implemented, e.g. office buildings, hotels, and/or hospitals for personnel.

Thus, there is need to develop further solutions for generating elevator calls.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present a method, an elevator control system, and an elevator system for generating an elevator call. Another objective of the invention is that the method, the elevator control system, and an elevator system for generating an elevator call enables a touchless generation of the elevator call.

The objectives of the invention are reached by a method, an elevator control system, and an elevator system as defined by the respective independent claims.

According to a first aspect, a method for generating an elevator call is provided, wherein the method comprises: obtaining image data representing at least one symbol illustrated on a symbol representing device from at least one image sensing device, identifying the at least one symbol from the obtained image data, and generating the elevator call in accordance with the identified at least one symbol.

The image sensing device may be an optical imaging device and the at least one symbol may be illustrated on the symbol representing device in a visual format.

Alternatively, the image sensing device may be a QR code reading device and the at least one symbol illustrated on the symbol representing device may be a QR code.

Alternatively or in addition, the at least one symbol may represent at least one of destination floor, direction of travel, an access code, and/or a special call.

The symbol representing device may be one of a mobile terminal device, a wearable device, a card, a plate, a tag device, and/or a piece of paper.

When the symbol representing device is the mobile terminal device, the mobile terminal device may generate dynamically the at least one symbol in accordance with a received user input.

The at least one image sensing device may be associated with at least one elevator user interface.

The at least one elevator user interface may be at least one of: a landing call device, an elevator car call device, and/or a destination call device, and wherein the generated elevator call may be a landing call, a car call, and/or a destination call.

According to a second aspect, an elevator control unit for generating an elevator call is provided, wherein the elevator control unit comprises: at least one processor, and at least one memory storing at least one portion of computer program code, wherein the at least one processor being configured to cause the elevator control unit at least to perform: obtain image data representing at least one illustrated on a symbol representing device from at least one image sensing device, identify the at least one symbol from the received image data, and generate the elevator call in accordance with the identified at least one symbol.

The image sensing device may be an optical imaging device and the at least one symbol may be illustrated on the symbol representing device in a visual format.

Alternatively, the image sensing device may be a QR code reading device and the at least one symbol illustrated on the symbol representing device may be a QR code.

Alternatively or in addition, the at least one symbol may represent at least one of destination floor, direction of travel, an access code, and/or a special call.

The symbol representing device may be one of a mobile terminal device, a wearable device, a card, a plate, a tag device, and/or a piece of paper.

When the symbol representing device is the mobile terminal device, the at least one symbol may be generated dynamically by the mobile terminal device in accordance with a received user input.

The at least one image sensing device may be associated with at least one elevator user interface.

The at least one elevator user interface may be a landing call device, an elevator car call device, and/or a destination call device, and wherein the generated elevator call may be a landing call, a car call, a destination call.

According to a third aspect, an elevator system for generating an elevator call is provided, wherein the elevator system comprises: at least one elevator shaft along which at least one elevator car is configured to travel between a plurality of floors, at least one image sensing device, and an elevator control unit as described above.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features.

The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an example of an elevator system according to the invention.

FIG. 2 illustrates schematically an example of a method according to the invention.

FIGS. 3A-3B illustrate schematically an example implementation of the elevator system according to the invention.

FIGS. 4A-4B illustrate schematically another example implementation of the elevator system according to the invention.

FIGS. 5A-5C illustrate schematically examples of a symbol representing device according to the invention.

FIGS. 6A-6E illustrate schematically examples of generating at least one symbol with a symbol generation application of a mobile terminal device being a symbol representing device according to the invention.

FIG. 7 illustrates schematically an example of components of the elevator control unit according to the invention.

### DESCRIPTION OF THE EXEMPLIFYING EMBODIMENTS

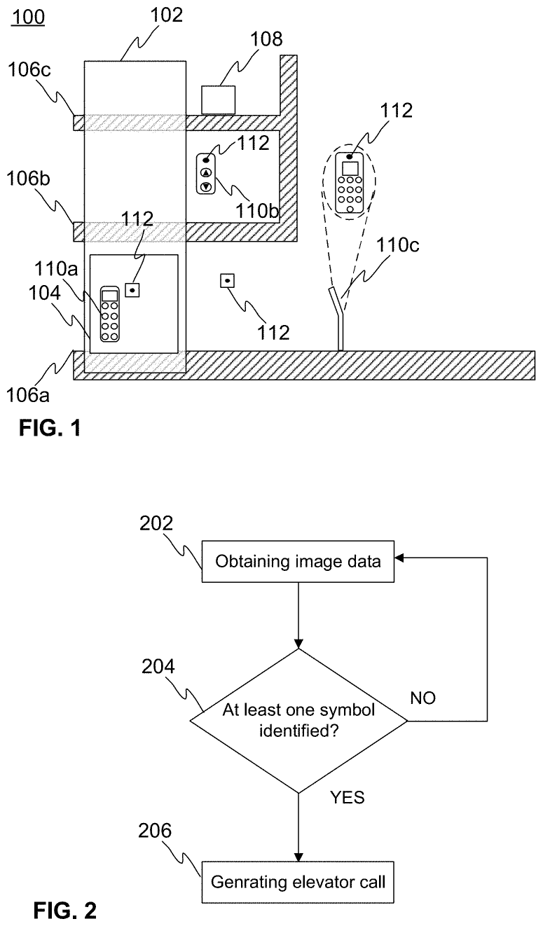

FIG. 1 illustrates schematically an example of an elevator system 100 according to the invention. The elevator system 100 comprises at least one elevator shaft 102 along which at least one elevator car 104 is configured to travel between a plurality of floors, i.e. landings, 106a-106c, an elevator control unit 108, at least one elevator user interface 110, and at least one image sensing device 112. For sake of clarity only three floors 106a-106c are shown in FIG. 1. The elevator system 100 further comprises a hoisting system configured to drive the at least one elevator car 104 along the at least one elevator shaft 102 between the floors 106a-106c. For sake of clarity the hoisting system is not shown in FIG. 1.

The at least one elevator user interface 110a-110c may be an elevator car call device 110a, a landing call device 110b and/or a destination call device 110c. The elevator system 100 may comprise an elevator car call device 110a arranged inside each elevator car 104. The elevator car call device 110a may be e.g. a car operating panel (COP). The elevator car call device 110a may comprise one or more elevator buttons for generating car calls to control at least one operation of the elevator system 100, e.g. to drive the elevator car 104 to a desired destination floor, open or close elevator doors (landing door(s) and/or elevator car door(s)), generating an elevator alarm, making an emergency call, etc. The car call may comprise an information of the destination floor to which the at least one elevator car 104 is desired to travel. Furthermore, the elevator system 100 may comprise at least one landing call device 110b arranged to each floor 106a-106c. The at least one landing call device 110b may be e.g. a landing call panel. The landing call device 110b may comprise one or more elevator buttons for generating landing calls to control at least one operation of the elevator system 100, e.g. to drive the at least one elevator car 104 to a desired departure floor 106a-106c, i.e. said floor 106a-106c where said landing call device 100b resides. The landing call may comprise information of the direction of travel, i.e. upwards or downwards, to which the at least one elevator car 104 is desired to travel. Alternatively or in addition, the elevator system 100 may comprise at least one destination call device 110c arranged to each floor 106a-106c. The at least one destination call device 110c may be e.g. a destination operation panel (DOP). The destination call device 110c may comprise one or more elevator buttons for generating destination calls to control at least one operation of the elevator system 100, e.g. to drive the at least one elevator car 104 first to a desired departure floor 106a-106c, i.e. said floor 106a-106c where said landing call device 100b resides, and then to a desired destination floor. The destination call may comprise information of the desired destination floor to which the at least one elevator car 104 is desired to travel. In the example of FIG. 1 the destination call device 110c is arranged to a separate support element, e.g. a stand, but the destination call device may also be arranged e.g. to a wall at the floor 106a-106c, e.g. within a landing area or an elevator lobby area.

The at least one image sensing device 112 may be implemented as a separate entity. The separate entity may be arranged to at least one floor 106a-106c, e.g. to a wall at the at least one floor 106a-106c within at least one landing area or elevator lobby area or next to a landing door of at least one elevator car 104; and/or inside the at least one elevator car 104, e.g. to a wall of the at least one elevator car 104. Alternatively, the at least one image sensing device 112 may be associated with the at least one elevator user interface 110a-110c. In other words, each of the at least one image sensing device 112 may be associated with one elevator user interface 110a-110c. In addition, the elevator system 100 comprise one or more elevator user interfaces 110a-110c without an image sensing device 112 associated with it. The image sensing device 112 may be arranged to the elevator user interface 110a-110c, e.g. integrated to the elevator user interface 110a-110c as the image sensing devices 112 of the elevator user interfaces 110b and 110c illustrated in the example of FIG. 1. In other words, the image sensing device 112 may be an internal entity of the elevator user interface 110a-110c. Alternatively, the image sensing device 112 may be arranged in a vicinity of, i.e. close to, the elevator user interface 110a-110c, e.g. to a wall or any another surface next to, above, or below the elevator user interface 110a-110c, or to a support element, e.g. a stand. The support element may be the same support element to which the elevator user interface 100a-110c may be arranged or a separate support element. In other words, the image sensing device 112 may be an external entity of the elevator user interface 110a-110c. In the example of FIG. 1 the image sensing device 112 associated with the elevator user interface 110a is an external entity of the elevator user interface 110a. The external entity herein means an entity that locates separate from the elevator user interface 110a-110c. The image sensing device 112 may be retrofitted into already existing elevator systems 100, especially as a separate entity and/or an external entity.

The elevator control unit 108 may be configured to at least control the operations of the elevator system 100. In the example of FIG. 1 the elevator control unit 108 locates in one of the floors 106c, but the elevator control unit 108 may also locate inside a machine room (for clarity reasons the machine room is not shown in FIG. 1). The elevator control unit 108 is communicatively coupled to the other entities of the elevator system 100. The communication between the elevator control unit 108 and the other entities of the elevator system 100 may be based on one or more known communication technologies, either wired or wireless. The implementation of the elevator control unit 108 may be done as a stand-alone control entity or as a distributed control environment between a plurality of stand-alone control entities, such as a plurality of servers providing distributed control resource.

Next an example of the method according to the invention is described by referring to FIG. 2. FIG. 2 schematically illustrates the invention as a flow chart.

At a step 202, the elevator control unit 108 obtains image data representing at least one symbol 310, 310a, 310b illustrated on a symbol representing device 320 from at least one image sensing device 112. In other words, the at least one image device 112 may produce, e.g. capture or record, the image data of the at least one symbol 310, 310a, 310b illustrated, i.e. presented, on the symbol representing device 320. The at least one image sensing device 112 then provides the produced image data to the elevator control unit 108. The at least one symbol 310, 310a, 310b illustrated on the symbol representing device 320 may be shown to the at least one image sensing device 112 via a user interaction. e.g. a user 330 may show the at least one symbol 310, 310a, 310b illustrated on the symbol representing device 320 to the at least one image sensing device 112, which the produces the image data.

The at least one image sensing device 112 may be an optical imaging device, e.g. a camera, with an image recognition function, e.g. using a machine vision. In case the at least one image sensing device 112 is an optical imaging device, the at least one symbol 310, 310a, 310b may be illustrated on the symbol representing device 320 in a visual format, i.e. in a human readable format. This enables a versatile image recognition function capable to recognize different symbols. The image recognition function may be an external function to the optical imaging device. In other words, the optical imaging device may be a simple optical camera and a processing unit, e.g. a processing unit 710 of the elevator control unit 108, communicatively coupled to the optical imaging device is configured to perform the image recognition function, e.g. identification of the at least one symbol 310, 310a, 310b from among the received image data. In this case the image data provided to the elevator control unit 108 comprises non-image recognition processed data, i.e. data without image recognition processing, and the image recognition function is performed by the elevator control unit 108. This enables low cost implementation of the at least one image sensing device 112. Alternatively, the image recognition function may be an internal function of the optical imaging device. In other words, the optical imaging device may be an optical camera comprising a processing unit configured perform at least partly the image recognition function, e.g. identification of the at least one symbol 310, 310a, 310b from among the received image data. In this case the image data provided to the elevator control unit 108 may comprise at least partly image recognition processed data and the image recognition function may be performed by the optical imaging device and/or the elevator control unit 108. The costs of the internal image recognition function implementation of the at least one image sensing device 112 may be higher than with the external image recognition function implementation of the at least one image sensing device 112. Alternatively, the at least one image sensing device 112 may be a QR code reading device. In case the at least one mage sensing device 112 is the QR code reading device, the at least one symbol 310, 310a, 310b illustrated on the symbol representing device may be a QR code. This may be a more costly implementation of the at least one image sensing device and only symbols presented in QR code format may be used.

The at least one symbol 310, 310a, 310b may represent at least one of: destination floor, direction of travel, e.g. upwards or downwards, an access code, and/or a special call. The special call may comprise at least one of: lengthened door open time; delayed closing of the elevator door(s); activating audible signaling and/or announcements, e.g. audible signal of elevator door(s) opening and or closing, floor announcements, etc.; prioritization of said special call; prevention of other similar specific call; generating visual indication of said special call, e.g. on a screen above the elevator car 104 at each floor 106a-106c; etc. Some examples of types of the special calls may comprise, but is not limited to, a call for physically disabled user, a call for visually handicapped user, a call for a user with a pet, a call for a user with a stroller, a call for a mailman or a courier, a rescue call, etc. The elevator control unit 108 may require access code to allow only authorized users to travel to one or more destination floors. The access code may be e.g. a pin code or a QR code.

The elevator control unit 108 may obtain, i.e. receive, the image data from the at least one image sensing device 112 constantly, i.e. continuously. Alternatively, the elevator control unit 108 may obtain, i.e. receive, the image data from the at least one image sensing device 112 only, when the at least one image sensing device 112 obtains, e.g. captures or records, image data or has obtained image data that may be provided to the elevator control unit 108. This reduces e.g. a needed data transfer and/or processing capacity. The elevator system 100 may further comprise an activation device, e.g. a motion sensing device or a pattern recognition sensing device, associated with the each of the at least one image sensing devices 112. The activation device may be configured to activate the image sensing device 112, i.e. activate the providing of the image data, in response to detecting motion or pattern at a predefined distance from the image sensing device 112. For example, when the activation device detects e.g. a motion of a user or the symbol representing device 320 within the predefined distance, the activation device may activate the at least one image sensing device 112. The elevator control unit 108 may obtain the image data directly from the at least one image sensing device 112 or via a cloud service or similar.

At a step 204, the elevator control unit 108 identifies, i.e. recognizes, the at least one symbol 310, 310a, 310b from the obtained image data. The identifying step 204 may comprise analyzing; processing, e.g. image recognition processing; and/or interpreting the obtained image data in order to identify the at least one symbol 310, 310a, 310b from among the obtained image data.

At a step 206, the elevator control unit 108 generates the elevator call in accordance with the identified at least one symbol 310, 310a, 310b. The elevator call generation step 206 may comprise converting the identified at least one symbol 310, 310a, 310b to a control signal comprising an instruction to control one or more operations of the elevator system 100 in accordance with the identified at least one symbol 310, 310a, 310b. The generated elevator call may be a car call, a landing call or a destination call. If the at least one image sensing device 112 from which the image data is obtained is associated with an elevator call device 110a, the generated elevator call is a car call. Alternatively, if the at least one image sensing device 112 from which the image data is obtained is associated with a landing call device 110b, the generated elevator call is a landing call. Alternatively, if the at least one image sensing device 112 from which the image data is obtained is associated with a destination call device, the generated elevator call is a destination call. This enables generation of a touchless elevator call, i.e. without a physical contact of the user 330 to at least one elevator user interface 110a-110c. The touchless elevator call corresponds to an elevator call generated via at least one elevator user interface 110a-110c via a physical contact of the user 330.

According to an exemplifying embodiment according to the invention, the access to the at least on elevator car 104 may be restricted with at least one door, e.g. building door and/or automatic door, or at least one gate device, e.g. security gate. At least one image sensing device 112 may be arranged to the other side of the door or the gate device than the at least one elevator car 104, i.e. the door or a gate device between the elevator car 104 and the at least one image sensing device 112. The elevator control unit 108 may further generate at the step 206 an access command in accordance with the identified at least one symbol 310, 310a, 310b representing the access code to a control unit of the door or the gate device to allow the access of the user via the door or the gate device.

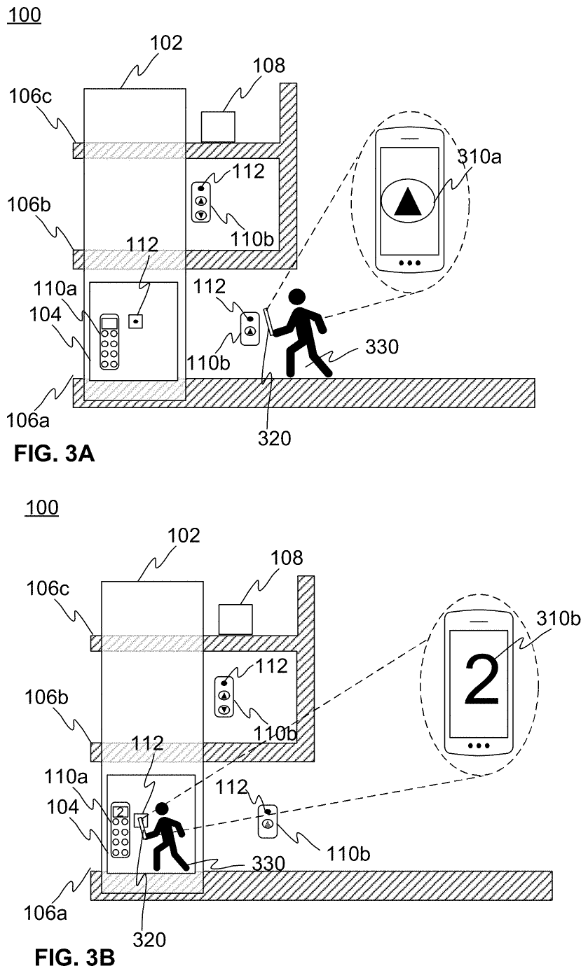

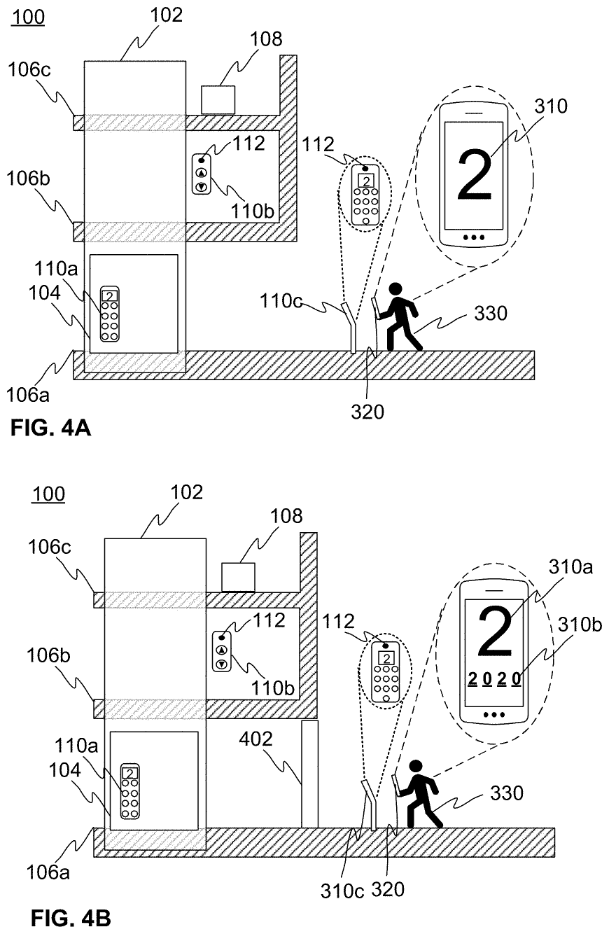

Next the invention is described referring to FIGS. 3A-3B and 4A-4B illustrating example implementations of embodiments of the elevator system 100 according to the invention. In the examples of FIGS. 3A-3B and 4A-4B the at least one symbol 310, 310a, 310b is illustrated in the visual format and the image sensing devices 112 are optical imaging devices, but the invention is not limited to that as described above. Moreover, in the examples of FIGS. 3A-3B and 4A-4B the at least one image sensing device 112 is associated with at least one elevator user interface 110a-110c. However, the invention is not limited to that and the at least one image sensing device may alternatively or in addition be implemented as a separate entity.

FIGS. 3A-3B illustrate schematically an example of an implementation in an elevator system 100 comprising at least one landing call device 110b at each floor 106a-106c, one elevator car call device 110a at each elevator car 104, and an image sensing device 112 associated with each landing call devices 110b and each elevator car call devices 110a. In the example of FIG. 3A first a touchless landing call may be generated via a touchless user interaction with the image sensing device 112 associated with the landing call device 110b at the floor 106a by a user 330. The user 330 carries the symbol representing device 320 having a first symbol 310a representing the desired travel direction, e.g. an up-direction arrow in this example, illustrated on the symbol representing device 320, i.e. on a screen of the symbol representing device 320 in this example. In FIG. 3A the symbol representing device 320 is illustrated inside the dashed ellipse to show a closer view of the symbol 310a illustrated on the symbol representing device 320. The user 330 shows the up-arrow symbol 310a illustrated on the symbol representing device 320 to the image sensing device 112 of the landing call device 110b at the floor 106a. The image sensing device 112 produces image data representing the up-arrow symbol 310a illustrated on the symbol representing device 320 and provides the image data to the elevator control unit 108, which obtains the image data from the image sensing device 112 of the landing call device 110b at the floor 106a. The elevator control unit 108 identifies the symbol 310a from the obtained image data and generates the landing call in accordance with the identified symbol 310a, i.e. generates the landing call to drive the elevator car 104 to the floor 106a.

In the example of FIG. 3B the elevator car 104 has arrived in response to the generated landing call to the floor 106a as described above referring to the example of FIG. 3A and the user 330 has entered the elevator car 104. In the example of FIG. 3B a touchless elevator call may be generated via a touchless user interaction with the image sensing device 112 associated with the elevator car call device 110a inside the elevator car 104 by the user 330. A second symbol 310b representing the destination floor, e.g. a floor number two in this example, is illustrated on the symbol representing device 320, i.e. on a screen of the symbol representing device 320 in this example. In FIG. 3B the symbol representing device 320 is illustrated inside the dashed ellipse to show a closer view of the symbol 310b illustrated on the symbol representing device 320. The user 330 shows the symbol 310b representing the second floor illustrated on the symbol representing device 320 to the image sensing device 112 of the elevator car call device 110b inside the elevator car 104. The image sensing device 112 produces image data representing the symbol 310b illustrated on the symbol representing device 320 and provides the image data to the elevator control unit 108, which obtains the image data from the image sensing device 112 of the elevator car call device 110a inside the elevator car 104. The elevator control unit 108 identifies the symbol 310b from the obtained image data and generates the car call in accordance with the identified symbol 310b, i.e. generates the car call to drive the elevator car 104 to the second floor 106b.

FIG. 4A illustrates schematically another example of an implementation in an elevator system 100 comprising at least one destination call device 110c at least one floor 106a-106n and an image sensing device 112 associated with each landing call devices 110b and each destination call devices 110c. The elevator system 100 of the example of FIG. 4A may further comprise one elevator car call device 110a at each elevator car 104 and/or at least one landing call device 110b at least one floor 106a-106n that may be, but are not necessary, associated with an image sensing device 112. In the example of FIG. 4A a touchless destination call may be generated via a touchless user interaction with the image sensing device 112 associated with the destination call device 110c at the floor 106a by the user 330. The user 330 carries the symbol representing device 320 having a symbol 310 representing the destination floor, i.e. a floor number two in this example, illustrated on the symbol representing device 320, i.e. on a screen of the symbol representing device 320 in this example. In FIG. 4A the symbol representing device 320 is illustrated inside the dashed ellipse to show a closer view of the symbol 310 illustrated on the symbol representing device 320. In addition, in FIG. 4A the destination call device 110c is illustrated inside a dotted ellipse to show a closer view of a surface of the destination call device 110c facing the user 330. The user 330 shows the symbol 310 representing the destination floor illustrated on the symbol representing device 320 to the image sensing device 112 of the destination call device 110c at the floor 106a. The image sensing device 112 produces image data representing the symbol 310 representing the destination floor illustrated on the symbol representing device 320 and provides the image data to the elevator control unit 108, which obtains the image data from the image sensing device 112 of the destination call device 110c at the floor 106a. The elevator control unit 108 identifies the symbol 310 from the obtained image data and generates the destination call in accordance with the identified symbol 310a, i.e. generates the destination call to drive the elevator car 104 first to the floor 106a and after the user 330 has entered the elevator car 104 at the floor 106n to the destination floor, e.g. the second floor 106b in this example. This, enables that the user 330 does not need to make a separate elevator car call from the elevator car 104, e.g. via the elevator car call device 110a.

FIG. 4B illustrates schematically another example of an implementation in an elevator system 100, which is otherwise similar to the elevator system 100 illustrated in the example of FIG. 4A, but the elevator system 100 further comprises a door or a gate device 402 between the elevator car 104 and the at least one image sensing device 112 at the floor 106a restricting access of unauthorized users to the elevator car 104 and one or more destination floors. In the example of FIG. 4B the touchless destination call may be generated via a touchless user interaction with the image sensing device 112 associated with the destination call device 110c at the floor 106a by the user 330. The user 330 carries the symbol representing device 320 having a first symbol 310a representing the destination floor, e.g. a floor number two in this example, and a second symbol 310b representing an access code, e.g. a pin code in this example, illustrated on the symbol representing device 320, i.e. on a screen of the symbol representing device 320 in this example. The user 330 shows the first symbol 310a representing the destination floor and the second symbol 310b representing the access code illustrated on the symbol representing device 320 to the image sensing device 112 of the destination call device 110c at the floor 106a. The image sensing device 112 produces image data representing the first symbol 310a representing the destination floor and the second symbol 310b representing the access code illustrated on the symbol representing device 320 and provides the image data to the elevator control unit 108, which obtains the image data from the image sensing device 112 of the destination call device 110c at the floor 106a. The elevator control unit 108 identifies the first symbol 310a and the second symbol 310b from the obtained image data. The elevator control unit 108 generates the destination call in accordance with the identified symbol 310a, as described above referring to the example of FIG. 4A, and the elevator control unit 108 further generates an access command in accordance with the identified symbol 310b to a control unit of the door or the gate device 402 to allow the access of the user 330 via the door or a gate device 402.

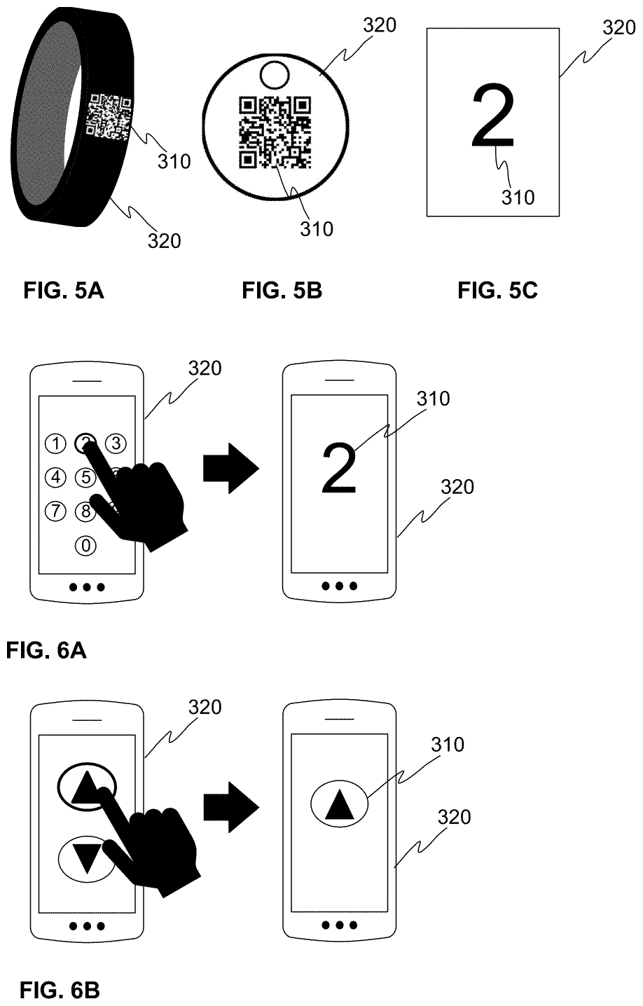

In the above examples the symbol representing device 320 is a mobile terminal device, e.g. a mobile phone or a tablet computer, but the invention is not limited to that. The symbol representing device 320 may be one of: the mobile terminal device; a wearable device, e.g. a watch, a bracelet, or any other wearable device; a card; a plate; a tag device; and/or a piece of paper. FIGS. 5A-5C illustrate schematically some examples of the different symbol representing devices 320 according to the invention. In the example of FIG. 5A the symbol representing device 320 is a wearable bracelet and the symbol 310 illustrated on the wearable bracelet is a QR code. In the example of FIG. 5B the symbol representing device 320 is a tag device and the symbol 310 illustrated on the tag device is a QR code. In the example of FIG. 5C the symbol representing device 320 is a card and the symbol 310 illustrated on the tag device is a visual symbol representing the destination floor. The at least one symbol 310, 310a, 310b may be a static symbol illustrated on the symbol representing device 320. Alternatively, when the symbol representing device 320 is the mobile terminal device, the mobile terminal device may generate dynamically the at least one symbol 310, 310a, 310b in accordance with a received user input. In other words, the mobile terminal device may comprise a symbol generation application configured to generate dynamically the at least one symbol 310, 310a, 310b in response to receiving user input. For example, the user input may comprise the destination floor, the direction of travel, the access code, and/or the special call.

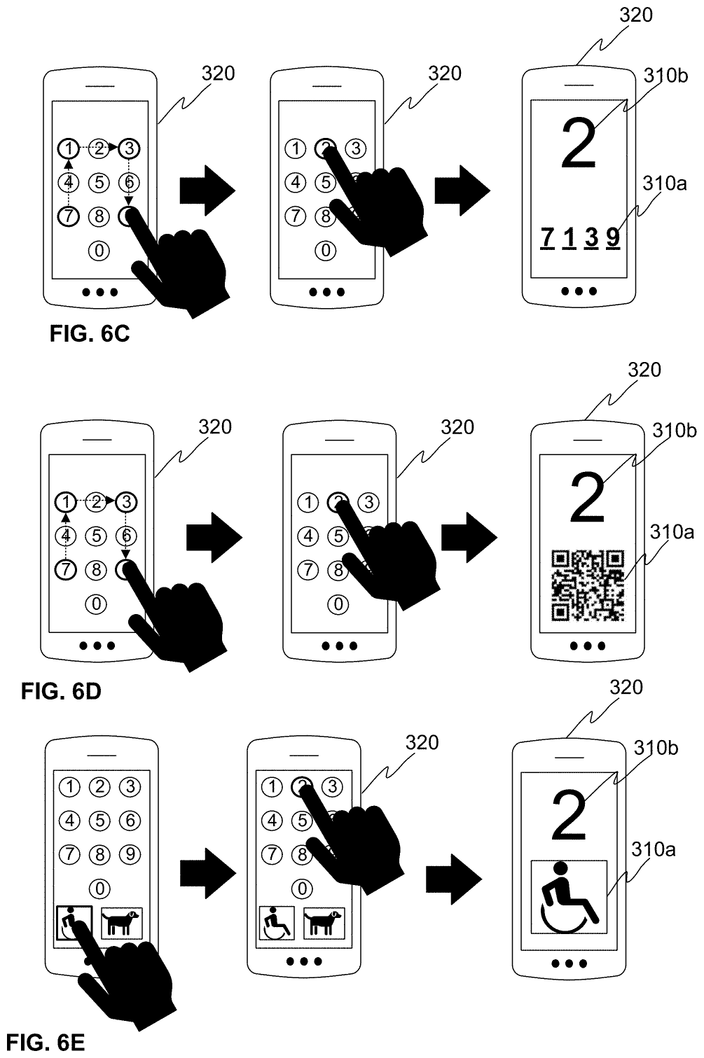

FIGS. 6A-6E illustrate some non-limiting examples of generating the at least one symbol 310, 310a, 310b with the symbol generation application of the mobile terminal device being the symbol representing device 320 in response to receiving the user input. In the example of FIG. 6A the symbol 310 representing the destination floor, e.g. floor two in this example, is generated in accordance with the received user input, e.g. the user selects, i.e. inputs, the destination floor number via a touch screen of the mobile terminal device as illustrated in the first step of FIG. 6A. The generated at least one symbol 310 is illustrated in the last step of FIG. 6A. In the example of FIG. 6B the symbol 310 representing the direction of travel, e.g. up-direction arrow, is generated in accordance with the received user input, e.g. the user selects, i.e. inputs, the direction of travel via the touch screen of the mobile terminal device as illustrated in the first step of FIG. 6B. The generated at least one symbol 310 is illustrated in the last step of FIG. 6B. In the example of FIG. 6C the first symbol 310a representing the access code, e.g. pin code, is generated in accordance with the received user input, e.g. the user selects, i.e. inputs, the access code via the touch screen of the mobile terminal device as illustrated in the first step of the FIG. 6C. In the example of FIG. 6C the second symbol 310b representing the destination floor, e.g. floor two in this example, is generated in accordance with the received user input, e.g. the user selects, i.e. inputs, the destination floor number via the touch screen of the mobile terminal device as illustrated in the second step of FIG. 6C. The generated at least one symbol 310 is illustrated in the last step of FIG. 6C. The example of FIG. 6D is otherwise similar to the example of FIG. 6C, but the first symbol 310a representing the access code is a QR code. The generated at least one symbol 310a, 310b is illustrated in the last step of FIG. 6D. In the example of FIG. 6E the first symbol 310a representing the special call, e.g. a call for physically disabled user in this example, is generated in accordance with the received user input, e.g. the user selects, i.e. inputs, the desired special call via the touch screen of the mobile terminal device as illustrated in the first step of the FIG. 6E. In the example of FIG. 6E the second symbol 310b representing the destination floor, e.g. floor two in this example, is generated in accordance with the received user input, e.g. the user selects, i.e. inputs, the destination floor number via the touch screen of the mobile terminal device as illustrated in the second step of FIG. 6E. The generated at least one symbol 310a, 310b is illustrated in the last step of FIG. 6E.

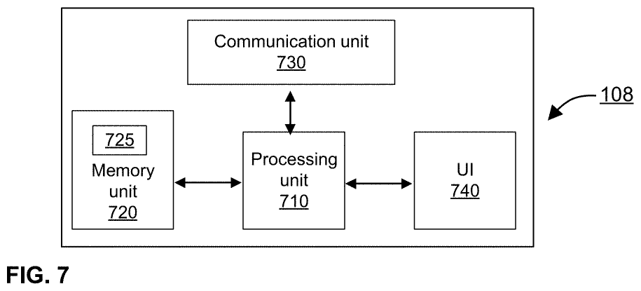

FIG. 7 schematically illustrates an example of components of the elevator control unit 108 according to the invention. The elevator control unit 108 may comprise a processing unit 710 comprising at least one processor, a memory unit 720 comprising at least one memory, a communication unit 730 comprising one or more communication devices, and possibly a user interface (UI) unit 740. The memory unit 720 may store portions of computer program code 725 and any other data, and the processing unit 710 may cause the elevator control unit 108 to implement, i.e. perform, at least the operation, i.e. the method steps as described above by executing at least some portions of the computer program code 725 stored in the memory unit 720. For sake of clarity, the processor herein refers to any unit suitable for processing information and control the operation of the elevator control unit 108, among other tasks. The operations may also be implemented with a microcontroller solution with embedded software. Similarly, the memory is not limited to a certain type of memory only, but any memory type suitable for storing the described pieces of information may be applied in the context of the present invention. The communication unit 730 may be based on at least one known communication technologies, either wired or wireless, in order to exchange pieces of information as described earlier. The communication unit 730 provides an interface for communication with any external unit, e.g. the at least one elevator user interface 110a-110c, the at least one image sensing device 112, one or more databases; and/or any external systems or entities. The user interface 740 may comprise I/O devices, such as buttons, keyboard, touch screen, microphone, loudspeaker, display, screen and so on, for receiving input and outputting information. The computer program 725 may be stored in a non-statutory tangible computer readable medium, e.g. an USB stick or a CD-ROM disc.

The above described method, elevator control unit 108 and the elevator system 100 according to the invention enables generation of a touchless elevator call, i.e. without a physical contact, e.g. a touch, of the user to the at least one elevator user interface 110a-110c. A touchless operation of the elevator user interfaces 110a, 110b, 110c, i.e. generation of the touchless elevator calls, reduces the risk of spreading of the viruses and bacteria. At least some of the embodiments of the invention enables substantially easy retrofitting of the touchless operation of the elevator user interfaces 110a, 110b, 110c into already existing elevator systems 100. Alternatively or in addition, the elevator system 100 with the touchless operation of the elevator user interfaces 110a, 110b, 110c may be implemented also in the environments, in which the access control cannot be implemented, e.g. airports, railway stations, underground station, shopping centers, hospitals, sports centers, exhibition centers, cruise ships, etc. At least some of the embodiments of the invention enables generation of the touchless elevator call by using at least one simple static symbol 310, 310a, 310b according to which the elevator call may be generated. At least some of the embodiments of the invention enables dynamical generation of the at least one symbol 310, 310a, 310b according to which the elevator call may be generated.

The specific examples provided in the description given above should not be construed as limiting the applicability and/or the interpretation of the appended claims. Lists and groups of examples provided in the description given above are not exhaustive unless otherwise explicitly stated.

1. A method for generating an elevator call, the method comprising: obtaining image data representing at least one symbol illustrated on a symbol representing device from at least one image sensing device,
identifying the at least one symbol from the obtained image data, and generating the elevator call in accordance with the identified at least one symbol.

2. The method according to claim 1, wherein the image sensing device is an optical imaging device and the at least one symbol is illustrated on the symbol representing device in a visual format.

3. The method according to claim 1, wherein the image sensing device is a QR code reading device and the at least one symbol illustrated on the symbol representing device is a QR code.

4. The method according to claim 1, wherein the at least one symbol represents at least one of destination floor, direction of travel, an access code, and/or a special call.

5. The method according to claim 1, wherein the symbol representing device is one of a mobile terminal device, a wearable device, a card, a plate, a tag device, and/or a piece of paper.

6. The method according to claim 5, wherein when the symbol representing device is the mobile terminal device, the mobile terminal device generates dynamically the at least one symbol in accordance with a received user input.

7. The method according to claim 1, wherein the at least one image sensing device is associated with at least one elevator user interface.

8. The method according to claim 7, wherein the at least one elevator user interface is at least one of: a landing call device, an elevator car call device, and/or a destination call device, and wherein the generated elevator call is a landing call, a car call, and/or a destination call.

9. An elevator control unit for generating an elevator call, wherein the elevator control unit comprises:
at least one processor, and
at least one memory storing at least one portion of computer program code,
wherein the at least one processor being configured to cause the elevator control unit at least to perform:
obtain image data representing at least one symbol illustrated on a symbol representing device from at least one image sensing device,
identify the at least one symbol from the received image data, and generate the elevator call in accordance with the identified at least one symbol.

10. The elevator control unit according to claim 9, wherein the image sensing device is an optical imaging device and the at least one symbol is illustrated on the symbol representing device in a visual format.

11. The elevator control unit according to claim 9, wherein the image sensing device is a QR code reading device and the at least one symbol illustrated on the symbol representing device is a QR code.

12. The elevator control unit according to claim 9, wherein the at least one symbol represents at least one of destination floor, direction of travel, an access code, and/or a special call.

13. The elevator control unit according to claim 9, wherein the symbol representing device is one of a mobile terminal device, a wearable device, a card, a plate, a tag device, and/or a piece of paper.

14. The elevator control unit according to claim 13, wherein when the symbol representing device is the mobile terminal device, the at least one symbol is generated dynamically by the mobile terminal device in accordance with a received user input.

15. The elevator control unit according to claim 9, wherein the at least one image sensing device is associated with at least one elevator user interface.

16. The elevator control unit according to claim 15, wherein the at least one elevator user interface is a landing call device, an elevator car call device, and/or a destination call device, and wherein the generated elevator call is a landing call, a car call, a destination call.

17. An elevator system for generating an elevator call, wherein the elevator system comprises:
at least one elevator shaft along which at least one elevator car is configured to travel between a plurality of floors,
at least one image sensing device, and
an elevator control unit according claim 9.

18. The method according to claim 2, wherein the at least one symbol represents at least one of destination floor, direction of travel, an access code, and/or a special call.

19. The method according to claim 3, wherein the at least one symbol represents at least one of destination floor, direction of travel, an access code, and/or a special call.

20. The method according to claim 2, wherein the symbol representing device is one of a mobile terminal device, a wearable device, a card, a plate, a tag device, and/or a piece of paper.
